(19) United States
(12) Patent Application Publication
(10) Pub. No.: US 2008/0202030 A1
(43) Pub. Date: Aug. 28, 2008

(54) Suspension Device and Running Carriage for a Sliding Door that Seals

(75) Inventors: Beat Heiniger, Schwarzenburg (CH); Manfred Lehmann, Schmitten (CH)

Correspondence Address: THE WEBB LAW FIRM, P.C., 700 KOPPERS BUILDING, 436 SEVENTH AVENUE, PITTSBURGH, PA, 15219, US

(73) Assignee: KABA GILGEN AG, Schwarzenburg (CH)

(21) Appl. No.: 11/666,107

(22) PCT Filed: Oct. 4, 2005
(86) PCT No.: PCT/CH2005/000575

§ 371 Date: Apr. 24, 2007

(30) Foreign Application Priority Data
Oct. 26, 2004 (CH) 1765/04

(51) Int. Cl. E05D 15/10

(52) U.S. Cl. 49/224; 49/221; 49/506

(57) ABSTRACT

The invention relates to a suspension device for at least one sliding door for closing a door opening or window opening. In this suspension device, the sliding door is displaceably mounted by two rollers that roll on at least one roll profile, and when entering the closing area, the sliding door is both displaced in the direction of the door opening as well as lowered. The rollers are arranged in an essentially vertical manner in a position outside of the closing area, and; the rollers, when entering the closing area, laterally tilt out of the vertical. The sliding door, in a pivotal motion about a horizontal axis, which is parallel to the plane of the sliding door, is displaced in the direction of the door opening and lowered.

### TECHNICAL FIELD

The present invention relates to a suspension device for at least one sliding door for closing a door- or window opening, wherein in said suspension device the sliding door is displaceably mounted by means of at least two track rollers running on at least one track profile, and wherein the sliding door is both displaced in the direction of the door opening as well as lowered when entering the closing area. Furthermore, the invention relates to a sliding door construction with such a suspension device as well as a method for mounting.

### BACKGROUND OF THE INVENTION

Sliding doors are used for closing wall openings by a wing of a door without the need for a space-consuming pivotal motion of the wing of the door. Usually mechanisms based on the use of track rollers guided on track rails are used for that purpose, which either carry the door at its upper edge and/or support it on its lower edge. Problematic in connection with sliding doors is the fact that, contrary to pivoting doors, a tight closure of the door opening is not easy, as the wing of the door is not guided into the door opening by a sliding movement but is only pushed in front of it.

In sliding doors that have sliding mechanisms with pure sliding movements, accordingly elaborate sealing constructions are necessary for an efficient sealing, that on the one hand seal the door in a closed state, on the other hand are inconspicuous and create as little friction as possible during the sliding closing process.

Alternatively it is possible to provide a sliding door with a sliding mechanism, in which the wing of the door is not only displaced parallel to the plane of the door opening when entering the closing area, but simultaneously at least partially enters the door opening.

On the one hand this is possible in that the door is displaced into the door opening by an according guidance of the sliding track vertical to the plane of the door when entering the closing area. Thereby the wing of the door is in a way guided into the door opening, or pressed onto sealings provided on the brim of the door opening, respectively. Such a mechanism can be realised comparably easily, but the forces needed for entering the sealing area are normally large, and that a sealing around the door opening can only be realized with elaborate sealings.

Alternatively it is possible to not only displace the wing of the door in the direction of the door opening when entering the sealing area, but to simultaneously lower it. This leads to a very tight and sealed closing of the door opening, but is connected with elaborate mechanics on the other hand.

Such systems are described for instance in EP-A-0 072 267 as well as in DE-A-23 54 484. The systems mentioned there describe a suspension device, wherein the track rollers, on which the wing of the door is carried, are not provided parallel to the plane of the wing of the door (or the axis of the track rollers is not provided vertically to the plane of the wing of the door, respectively), as is the case with regular track rollers, but wherein the track rollers are disposed at an angle. The track rail on which the track rollers are guided, is slightly lowered in the entrance area to the closing area and the tilt of the axis of the track rollers is adjusted in a way that the entire door is displaced linearly slanted downwardly in direction of the door opening as well as lowered when entering the closing area. In order to absorb the lateral forces which in this connection are effective not only in the moment of closure, an elaborate additional roller mechanism is necessary. Especially in case of the use of heavy wings of doors or motor-driven wings of doors, respectively, such a mechanism proves to be insufficient and too susceptible.

### SUMMARY OF THE INVENTION

The invention is based on the objective to propose a constructively simple, stable construction of a suspension device for a door, which should be displaced both in the direction of the door opening as well as downwardly when entering the closing area. Furthermore, an objective is to propose a carriage for such a construction. Specifically, a suspension device for at least one sliding door is dealt with, for closing a door- or window opening, wherein the at least one sliding door is displaceably mounted by means of at least two track rollers running on at least one track profile and wherein said sliding door is both displaced in the direction of the door opening as well as lowered when entering the closing area.

The solution to this is achieved in that the track rollers are (tiltably) moveably connected with the sliding door, in that the track rollers are arranged essentially vertically in their position outside of the closing area, and in that the track rollers tilt laterally out of the vertical when entering the closing area, whereby the sliding door is displaced in the direction of the door opening by a pivotal motion about a horizontal axis arranged parallel to the plane of the sliding door and is concomitantly lowered.

The core of the invention thereby is to provide track rollers which, in an opened state, when the door is freely suspended, as well as during the main part of the sliding door process, are vertically aligned, i.e. their horizontal axis is vertical to the plane of the sliding door. Thereby the resulting traction forces due to gravity of the door are transferred optimally onto the track rollers or the track profile, respectively, which results in an optimal stability, low frictional losses as well as a high reliability. If track rollers are provided, as suggested for instance in said state of the art, in EP-A-0 072 267, in an orientation, in which the rotating axis of the track rollers is not arranged horizontally, the resulting lateral forces have to be absorbed, which normally is connected with frictional losses and constructively complex components.

Furthermore, according to the invention, the track rollers lead, when tilting, to a pivotal motion of the door into the door opening, due to the moveable connection of the axis of the track rollers with the sliding door. Contrarily, the mechanism according to EP-A-0 072 267 doesn't lead to a pivoting, but to a linear movement from obliquely above into the frame of the door. It can easily be understood that the entrance into a sealing in a linear movement from obliquely above is more material-wearing and especially less efficient. The pivotal motion according to the mechanics of the invention however guides the door around the upper bottom edge of the frame of the door in a natural way and as far as possible in a movement from the front side into the sealing area and not laterally under shear strain.

According to a first preferred embodiment the mechanics are provided in a way that the displacement and the lowering of the sliding door are achieved mainly due to gravitational force. In other words, the energy for the tilting of the mechanism with the track rollers in the suspension device is provided by the gravitational force of the door, which results in the motor not having to provide a higher power in order to guide the door into the sealings when entering the closing area. In order to control the tilting process especially under the effect of the gravitational force of the door, corresponding means are provided which prevent the tilting from taking place already before the entrance into the closing area.

According to a further preferred embodiment, these means are provided in the form of at least one guiding roll. The axis of the guiding roll is normally rigid with respect to the axis of the track rollers. Preferably this guiding roll prevents in its position outside of the closing area a tilting of the track rollers (e.g. under the effect of the gravitational force of the door) and allows a targeted tilting of the track rollers when entering the closing area. For this purpose the guiding roll preferably is guided on/by a corresponding link, for instance in the form of a guiding rail. This guiding rail has a ramp in the form of a guiding device in the closing area or the entrance area into the closing area, respectively. This ramp or guiding device, respectively, can herein be provided one-sided, i.e. it can be provided merely for controlling the willingly resulting lateral pressure. (torque, for instance due to the gravitational force of the door in combination with the selected lever conditions) of the guiding roll. The ramp or guiding device, respectively, however can also be provided in a two-sided guiding way, i.e. it can also force the guiding roll into the tilted position, should the lateral pressure not suffice, which especially can happen during a rapid entering into the closing area.

According to a further preferred embodiment of the invention, the guiding roll is provided in a way that its axis is oriented essentially vertically in its position outside of the closing area (i.e. the guiding roll is orthogonal to the track rollers), and that its axis is tilted synchronously to the tilting of the track rollers when entering the closing area (for the axes of the track rollers and of the guiding roll are provided rigidly with respect to each other).

In order to achieve optimal lever effects, the guiding roll is preferably located above the track rollers. Therein it is shown to be advantageous to let the axis of the guiding roll in its position outside of the closing area substantially align with the running surface of the track rollers, as then among other things the frictional losses can be kept at a minimum.

Normally the entering into the closing area has to be adjusted during the mounting process or during a setting. This can either be ensured by a corresponding changeability of the ramp of the guiding rail, but can also, at least with respect to the time of entrance into the closing area, be ensured in that the guiding roll is adjustably provided in its position along the direction of displacement of the sliding door.

According to a further preferred embodiment, the sliding door is provided with at least one carriage unit, which is moveable around at least one rotating axis, which is arranged horizontally and parallel to the plane of the sliding door. Hereby the track rollers are provided on the part of the carriage unit which is moveable with respect to the sliding door. Preferably the rotating axis is arranged offset in the direction away from the door opening from the roller-plane (or more precisely the central roller-plane, respectively) of the track rollers. This arrangement of the rotating axis results in a lever effect, during which the gravitational force of the door results in a tilting of the track rollers, insofar as the construction, which holds the track rollers, for instance is not held in its position by the guiding roll. Accordingly, it can be ensured by this arrangement of the rotating axis, that the sliding door is guided into the door opening under the effect of its own gravitational force, as mentioned above.

These lever conditions can be adjusted especially well if the rotating axis is located substantially in the area of the top edge of the sliding door.

A preferred embodiment of the invention is further characterized in that the carriage unit comprises at least two carriage plates which are attached to the sliding door moveably around said rotating axis, wherein on each of these carriage plates at least one track roller, preferably two track rollers, are provided. The carriage plates are preferably rigidly connected to each other by a tilting rod (it can be a separate component, resulting in increased flexibility, or an element provided as one piece with the carriage plates), and there are means provided on the tilting rod for the control of the tilting of the track rollers when entering the closing area. These means can again preferably be a track roller. The tilting rod even more preferably is adapted as a rail (or profile) attached in the area of the top edge of the corresponding carriage plate, on which rail (or profile) one (or also more than one) guiding roll is provided between the carriage plates on the top side with a vertical orientation of the axis of the guiding roll. The guiding roll thereby can on the one hand be located in a minimally disturbing way between both carriage plates and the forces acting upon the track roller are at the same time optimally distributed. In addition, in this arrangement of the guiding roll, the guiding roll can for instance be provided adjustably on the tilting rod, which allows a setting of the closing area.

An additional preferred embodiment is characterized in that the track profile has a convex running surface directed upward and the track rollers have a corresponding concave running surface. On the one hand this arrangement results in a self-stabilisation of the track rollers on the running surface, on the other hand this arrangement is also optimally adapted to the tilting of the track rollers in the closing area and reduces the forces resulting from the tilting and the resulting friction. In order to further ensure a maximal stability of the device, it is advantageous, in addition or alternatively, to provide the track profile with a concave opposite surface directed downward, in which at least one guiding roll (which can for instance be adapted adjustably convex) runs, the axis of which is arranged parallel to the direction of the axis of the track roller.

As already mentioned, a substantial part of the energy for the entrance into the closing area is preferably provided by the gravitational force of the door. Accordingly, this energy has to be applied again when opening the door. In order to prevent that large forces are necessary for that purpose, it can be advantageous to provide an energy storage device, for instance in the form of a spring, an elastic device or a shock absorber, which takes up energy when entering the closing area such that said energy is available when exiting the closing area.

Preferably the sliding door is an automatic sliding door. Accordingly, it for instance comprises in its suspension (or also within the door, or an upper rail of the. door, respectively) a motor, as well as preferably in addition a control unit, wherein the motor displaces the sliding door for instance over a toothed drive belt or a toothed bar or the like, wherein for instance the toothed drive belt is fixedly connected with the carriage unit.

Furthermore, the present invention concerns a sliding door construction with a suspension device as given above. In order to ensure in such a sliding door construction the entrance into the door opening not only in the area of the suspension, but also in the lower area, advantageously at least one bottom guidance is provided in the floor area. These bottom guidances also force the door into the door opening, for instance over tilted links and accordingly e.g. tilted edges of the door.

In addition, the present invention concerns a method for mounting a suspension device or a sliding door construction, respectively, as mentioned above, wherein said method is characterized in that first a carrier plate is attached to the upper door lintel, then a track profile and a guiding rail are attached to the carrier plate, after which the sliding door is slid into the suspension device from the side or from the front, whereby the track rollers of the sliding door are mounted onto the track profile and the guiding roll of the sliding door is inserted into the guiding rail.

Further preferred embodiments of the invention are described in the dependent claims.

### SHORT DESCRIPTION OF THE FIGURES

The invention shall be more closely described as follows according to embodiments in connection with the drawings. Described are in:

FIG. 1 full views of a sliding door according to a first embodiment with a suspension device, a) perspective view, b) front view, wherein the front cover has been removed, c) side view of the sliding door, wherein the lateral cover has been removed, d) detailed view of a bottom guidance;

FIG. 2 a) a perspective view of an entire carriage unit according to a first embodiment with both carriage plates, b) the rear side of a carriage plate, c) a horizontal cut through the area of the rotating axis; FIG. 3 a) a vertical cut vertical to the plane of the wing of the door through the suspension device according to a second embodiment, position open, b) a vertical cut vertical to the plane of the wing of the door through the suspension device, position closed;

FIG. 4 a perspective illustration from the side of a third embodiment with an opened cover;

FIG. 5 a) a vertical cut vertical to the plane of the wing of the door through the suspension device according to a third embodiment, position open, b) a vertical cut vertical to the plane of the wing of the door through the suspension device, position closed;

FIG. 6 a) a perspective view of an entire carriage unit according to the third embodiment with both carriage plates, including ramp (not connected to carriage unit), position open, b) analogous to FIG. 6a), position closed.

### DETAILED DESCRIPTION OF THE PREFERRED EMBODIMENTS

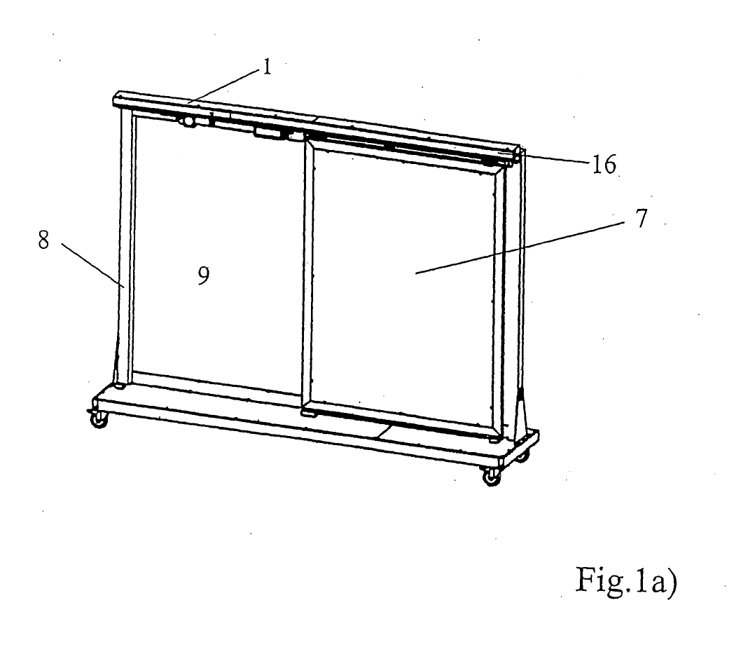

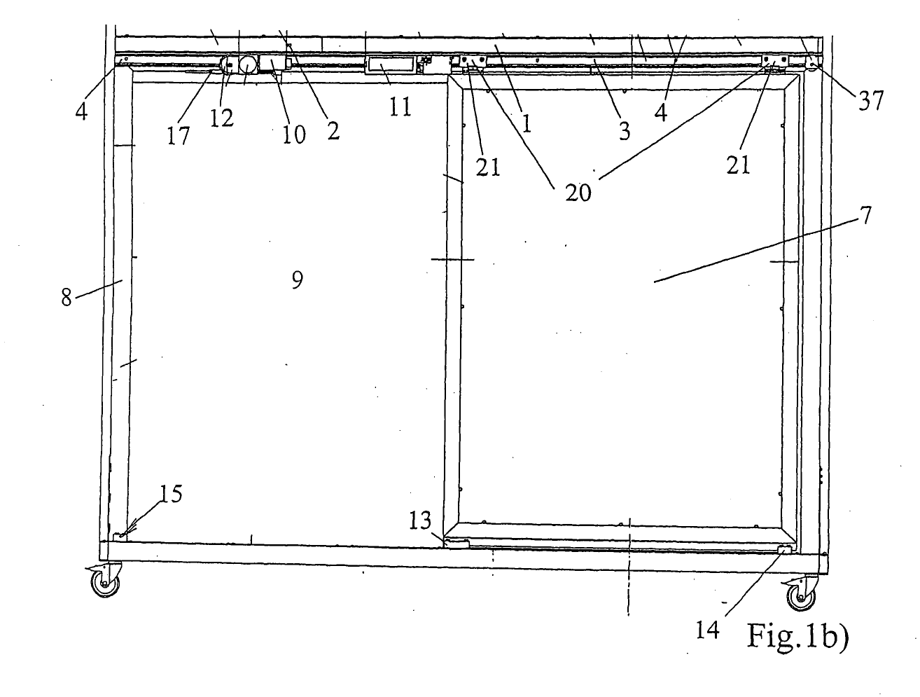

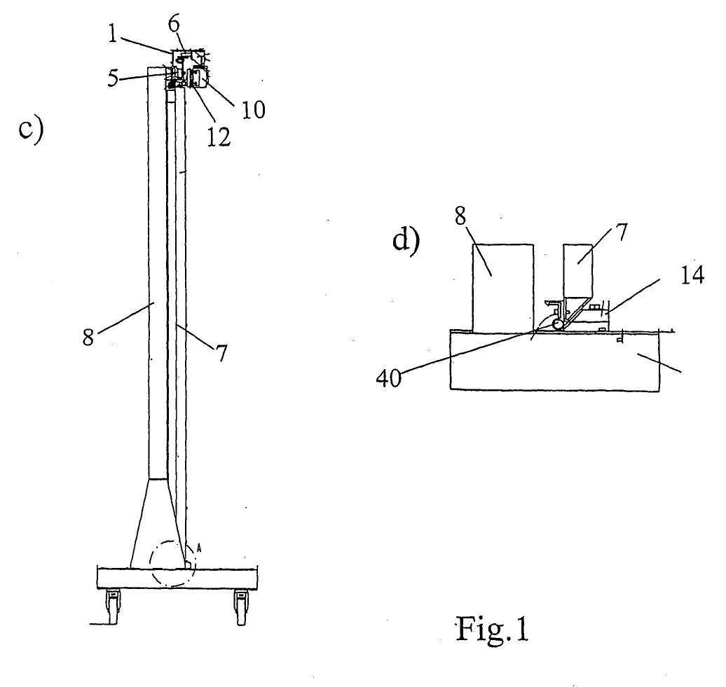

FIG. 1a) shows a sliding door 7 including the corresponding frame 8 in a perspective view. The sliding door 7 is illustrated in FIG. 1a) in the open position, i.e. the door opening 9 is open, and it can be seen how a suspension device, which has a carrier plate 1 in the area facing the wall and a cover 16 in the area facing the front, is arranged in the area of the top edge of the sliding door 7. Here, the sliding door is provided as a test construction with a driveable top piece.

FIG. 1b) shows a frontal view of such a door, wherein the cover 16 has been removed for the visualization of the elements in the suspension device. Furthermore, FIG. 1c) shows a lateral view of this door. It can be recognized how the carrier plate 1 is attached to the wall or the door lintel, respectively, by means of screws 2. Onto this carrier plate 1 a track profile 3 is also attached horizontally by means of screws 4. On this track profile 3 the sliding door 7 is displaceably mounted. For this purpose a carriage unit 20 is provided which has two carriage plates 21.

Furthermore, a motor 10 is connected with the suspension device or the carrier plate 1, respectively, in a locally fixed way, as well as a control unit 11. The motor 10 has a drive wheel 12, by which a toothed drive belt 32 is driven. The motor 10 is located essentially above the door opening 9, and accordingly the toothed drive belt 32 is guided over a rear guiding roll 37 at the rear end of the suspension device and is fixedly connected over a corresponding carrier 31 with the rear track roller plate 21, i.e. which faces away from the door opening 9. Furthermore a spring 17 can be recognized which is stretched when entering the closing area and serves as an energy storage device for a subsequent opening of the door.

Also recognizable in FIG. 1b) are bottom guidances, which serve to guide at the bottom the sliding door 7, which as such is only suspended on the top. For this purpose there is a rear bottom guidance 14 as well as a middle bottom guidance 13. The rear bottom guidance 14 serves to prevent the sliding door in the open position from pivoting to the front. The middle bottom guidance 13 on the one hand controls the position of the sliding door 7 in the open position, but simultaneously also the behavior of the sliding door 7 when entering the closing area, i.e. when the sliding door is almost entirely displaced in front of the door opening 9 and only the last few millimetres or centimetres, respectively, remain to be driven. When entering the closing area, the front bottom guidance 15 also takes effect. For this purpose, the bottom guidances are for example provided with an inclined surface, as illustrated in FIG. 1d), which cooperates with a correspondingly tilted bottom edge of the sliding door. The bottom guidance can force the door in the direction of the door opening by a corresponding guidance of the tilted surface when entering the closing area, whereby it ensures a sufficient pressing into or onto the sealing also in the floor area. The sealing 40 can thereby be provided on the sliding door, as illustrated in FIG. 1d), and/or at the edge of the door opening.

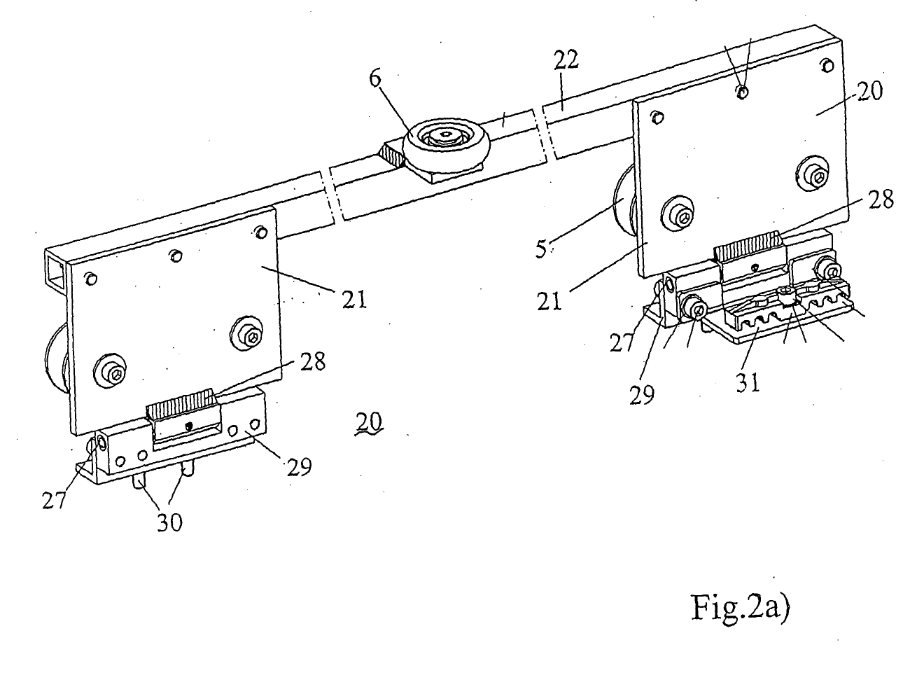

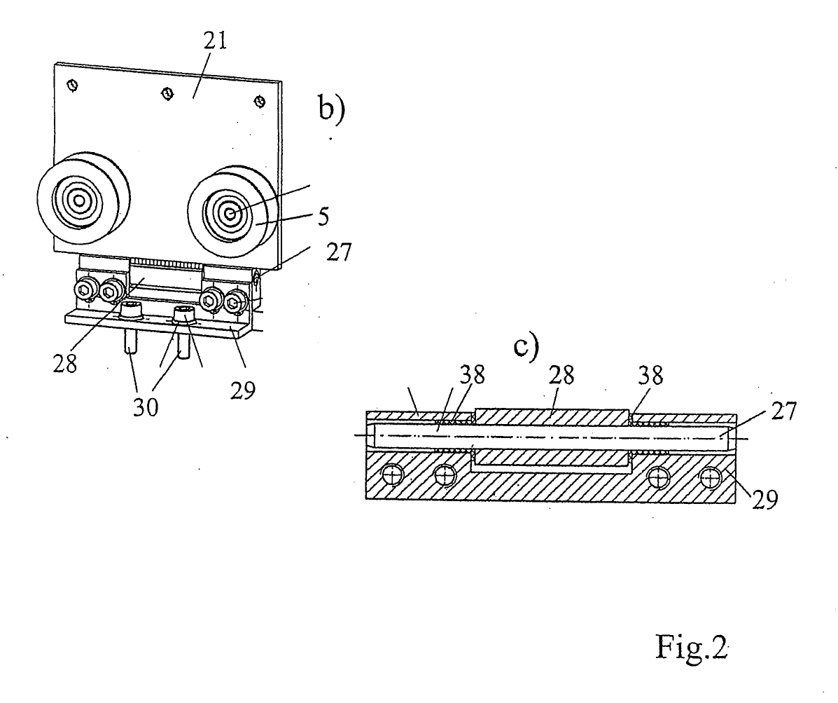

FIG. 2a) shows a simple construction of a first embodiment of a carriage unit 20. The carriage unit 20 comprises two carriage plates 21, which are connected with each other with a tilting rod 22 to form the carriage unit 20. On each of these carriage plates 21 one pair of track rollers 5 is provided in sequence. The track rollers 5 have a concave running surface (see also FIG. 2b), which is adjusted to the form of the profile rail 3. Alternatively, it is possible to provide convex track rollers 5 and accordingly a concave running surface of the track profile 3. The axis of the track rollers 5 is horizontal and thus vertical to the plane of the sliding door while the sliding door is open, and also during almost the entire closing process, respectively, i.e. the track rollers 5 are vertically aligned and can optimally take up the gravitational forces resulting from the sliding door 7.

Furthermore, a holder for the axis 28, in which the rotating axis 27 is guided, is attached to the carriage plates 21. On the other hand, a fastening element 29 is attached to the sliding door 7 by means of screws 30, and this fastening element 29 serves as a second holder of the rotating axis 27.

Accordingly, the sliding door 7 is movably connected with the carriage plate 21 rotatably about the rotating axis 27. The rotating axis is located below the carriage unit 20. As is recognizable in FIG. 2c), a slide bearing is introduced from both sides in order to facilitate this rotation. It is also possible to provide a different bearing, such as for instance a roller bearing. Thereby, the rotating axis 27 is not located in the line of gravity of the track rollers 5, but intentionally displaced to the front thereof, i.e. away from the door opening. This results in a tilting moment of the carriage unit 20 due to the gravitational force of the sliding door 7.

This tilting moment on the carriage plates 21, or on the entire carriage unit 20, respectively, is used when entering the closing area. In the open state illustrated in FIG. 1a) this tilting moment is absorbed by the guiding roll 6, which is attached to the tilting rod 22. It proves to be advantageous to provide the guiding roll 6 laterally displaceable (especially in the direction of the tilting rod 22) on the tilting rod 22, so that an adjustment of the closing area is easily possible. The guiding roll 6 is attached at the top of the carriage unit 20 and is arranged horizontally, i.e. the axis of the guiding roll runs vertically. The guiding roll 6 is guided in a guiding rail 24, or along it, respectively, and the tilting moment is absorbed by a vertical shoulder of the guiding rail 24, i.e. the guiding roll 6 runs along a substantially vertical wall of the guiding rail 24.

FIG. 3 shows a vertical cut through a second embodiment in a plane vertical to the sliding door 7, wherein in FIG. 3a) the vertical position 33 of the carriage unit 20 is illustrated, i.e. the situation when the sliding door is entirely or partially open. In FIG. 3b) the tilted position 34 of the carriage unit 20 is illustrated, i.e. the situation when the sliding door is entirely slid into the door opening 9, i.e. when the sliding door 7 is entirely closed.

Basically it is recognizable how the carrier plate 1, together with the cover 16, forms a substantially closed box, in which the motor 10 and the control unit 1 1 as well as further functional elements as bus connections, power supply etc. are arranged. These further functional elements can be attached in corresponding profiled projections, as shown in FIG. 3, which are provided in the inner area of the carrier plate 1. These profiled projections can for instance have the form of rails, such that the further functional elements along the suspension device can be positioned according to the needs, which is very advantageous in the light of the fact that a suspension device normally has to be adjusted to the length of the door opening during the mounting process.

The track profile 3 is formed as a profile rail, which can be screwed into corresponding prepared holes or profile ribs of the carrier plate by means of screws 4. The profile rail has a horizontal running surface, which is formed as a bent profile, i.e. which provides the track rollers 5 with a convex running profile toward the top, and which has a concave running surface for a guiding roll 19 or an opposite roll toward the bottom. The carriage unit 20 comprises two carriage plates 21, as already mentioned with respect to the first embodiment. These two carriage plates 21 are connected with each other over a tilting rod 22. A pair of track rollers 5 is arranged sequentially on each carriage plate 21. The track rollers 5 have a concave running surface, which is adapted to the form of the profile rail 3. When the sliding door is open, and also during almost the entire closing process, respectively, the axis of the track rollers horizontal and thus vertical to the plane of the sliding door, i.e. the track rollers 5 are vertically aligned and thereby can optimally absorb the gravitational forces resulting from the sliding door 7. In addition, at least on one of the carriage plates, preferably on both carriage plates, at least one guiding roll 19 with one axis parallel to the axis of the track rollers 5 is provided, wherein said guiding roll 19 has a convex running surface and engages in the track profile 3 from below and thereby stabilizes the carriage unit 20. The track profile is quasi embraced by the track rollers and the guiding roll.

In addition, a holder for the axis 28, in which the rotating axis 27 is guided, is attached to the carriage plate 21. A fastening element 29, which can comprise a number of interconnected parts, is attached to the sliding door 7 by means of screws 30, and this fastening element 29 or parts thereof, respectively, serves as a second holder for the rotating axis 27. Accordingly, the sliding door 7 is moveably attached with the carriage plate 21 rotatably about the rotating axis 27.

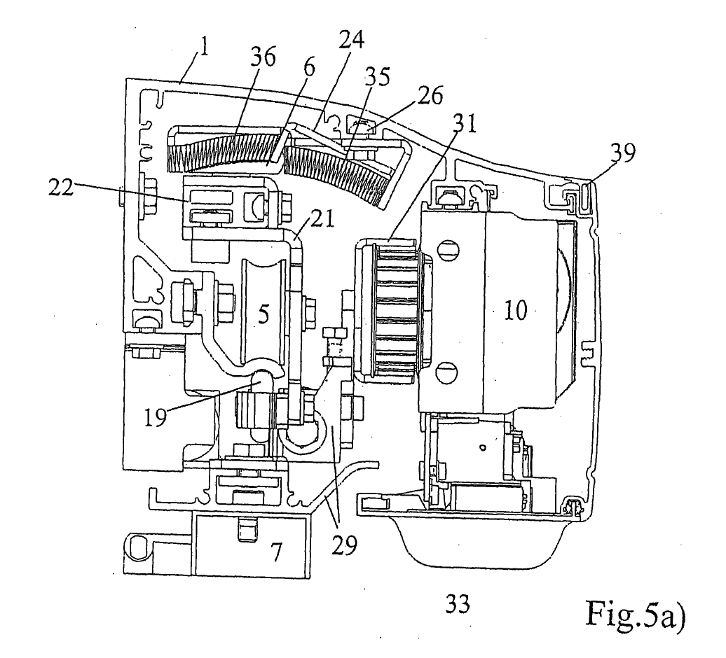

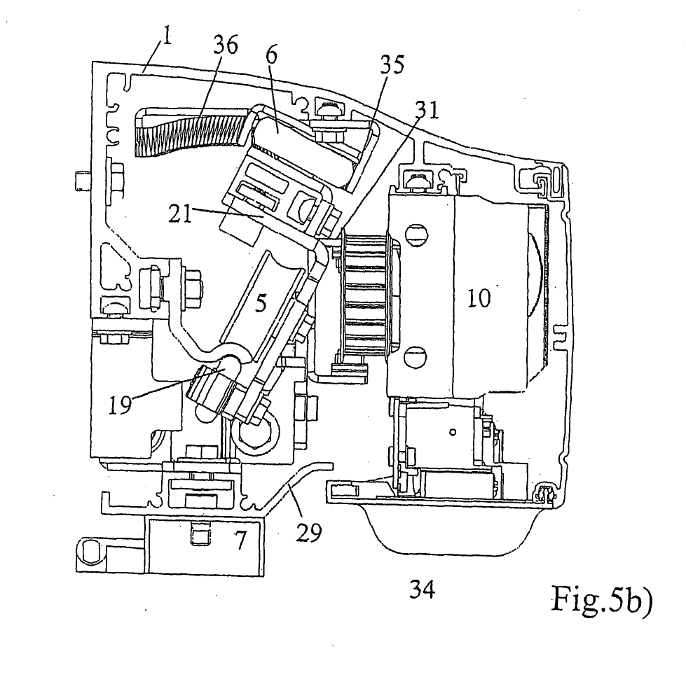

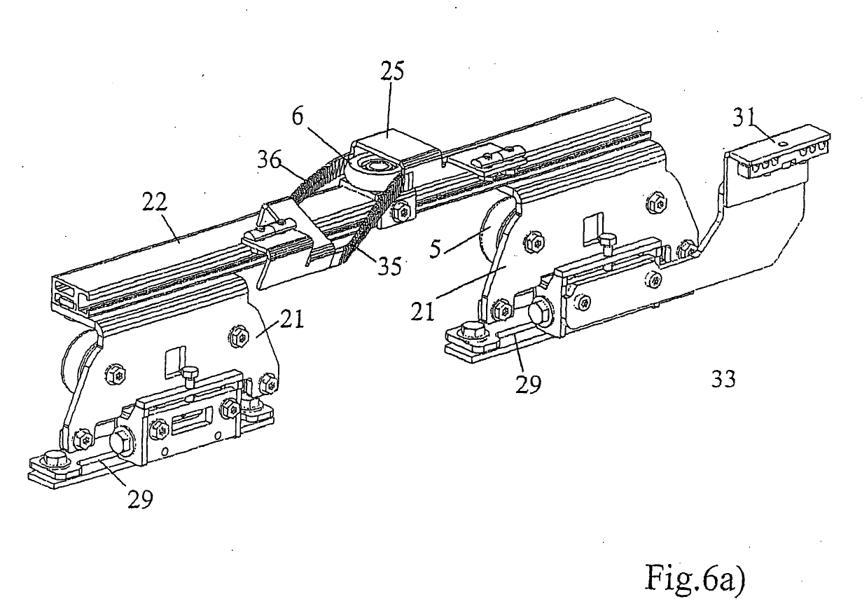

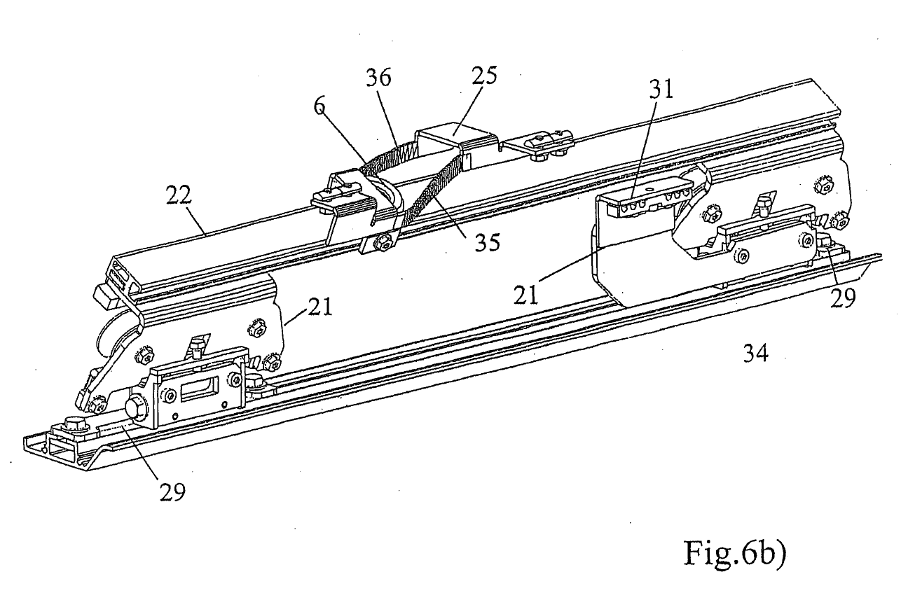

A guiding roll 6 is attached to the tilting rod 22. This guiding roll 6 prevents an uncontrolled tilting of the carriage unit 20. Accordingly, a locally fixed guiding rail 24 is provided, on which the guiding roll 6 runs. In the open area of the sliding door, or until the entrance into the closing area, respectively, this guiding rail 24 is responsible that the carriage unit 20 remains in its vertical position, as illustrated in FIG. 3a), i.e. it absorbs the tilting moment acting in a clockwise direction over a shoulder located on the right side of the guiding roll 6. In particular, the guiding rail 24 has a ramp 25, which is arranged such that the guiding roll 6 runs on this ramp 25 when entering the closing area. The roll 6 thereby follows the outer guidance 35, i.e. in FIG. 3a) and 3b) the guidance on the right as a result of the above mentioned tilting moment. Should the tilting moment not suffice, in addition an inner guidance 36 of the ramp can be provided (see in particular FIG. 5 and 6) for safety reasons. As the guiding roll 6 follows this ramp, the carriage unit 20 tilts to the right in a clockwise direction, in order to arrive at a position as illustrated in FIG. 3b) when the door is closed. During this tilting the sliding door 7 is pivoted in a rotating motion about a horizontal axis arranged parallel to the plane of the sliding door 7, while of course a last pushing movement is exercised simultaneously. Hereby a tilting of about 30-45° takes place, whereby the door in total is simultaneously lowered and displaced in the direction of the door opening. For instance, the lowering is 6.5 mm and the displacement into the door opening is 6.5 mm. The situation after an entire run-in into the closing area is illustrated in FIG. 3b, wherein it can be recognized how the entire carriage unit is tilted in clockwise direction and stabilized in this position by the guiding rail 24 or the end portion of the ramp 6, respectively.

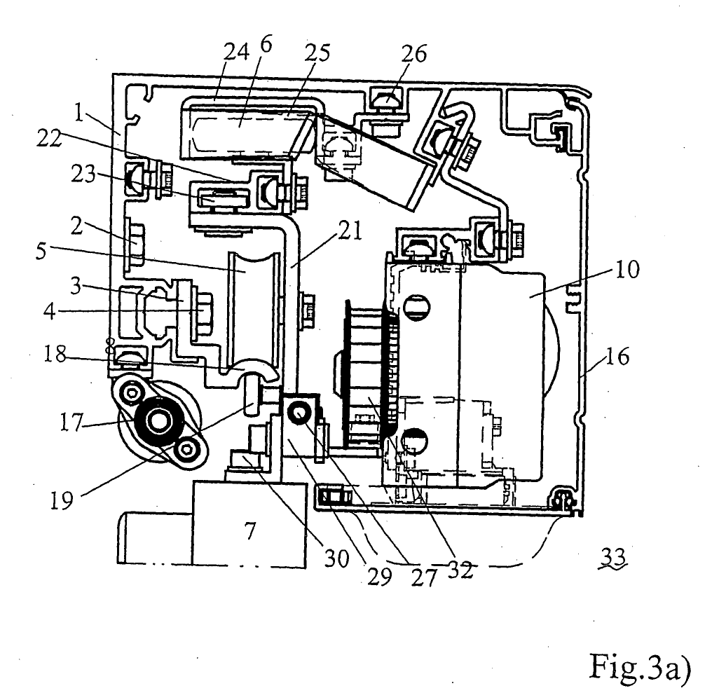

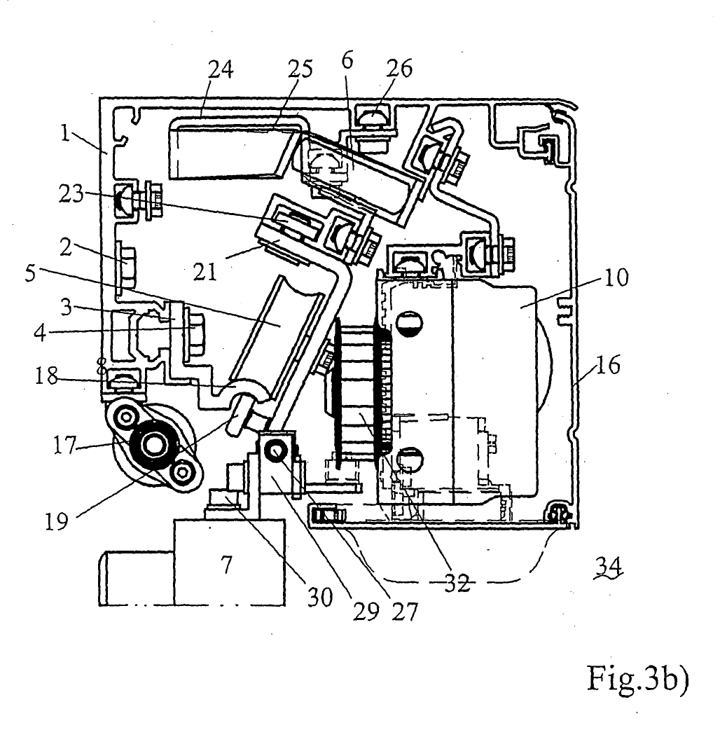

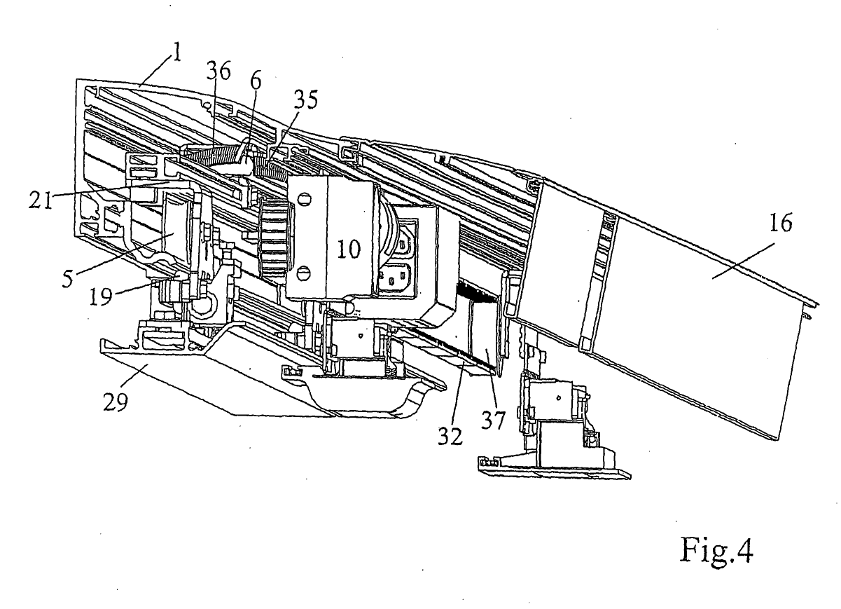

In FIG. 4, a further embodiment of a suspension device is illustrated in a perspective view. Again, a carrier plate 1 is provided substantially in a L-shape opened toward the bottom, wherein said carrier plate 1 is provided with different longitudinal profile grooves on its inner side, in order to fasten the track profile 3 on the inside, as well as the guiding rail 24 and further functional elements as for instance the motor 10, the rear guiding roll 37, the control unit 11, etc. The front cover 16 is in this case formed in an L-shape and in a two-part form as well. The front cover 16 is opened in FIG. 4, as this can be useful for maintenance or mounting purposes. For this purpose the front cover 16 is moveably attached to the carrier plate 1, wherein for fixation of this movability, as illustrated in FIG. 5a), a fixing rail 39 can be provided.

FIG. 5 shows a vertical cut through said third embodiment in a plane vertical to the sliding door 7, wherein in FIG. 5a) the vertical position 33 of the carriage unit 20 is illustrated, i.e. the situation when the sliding door is entirely or partially open. In FIG. 5b) the tilted position 34 of the carriage unit 20 is illustrated, i.e. the situation when the sliding door is entirely driven into the door opening 9, i.e. when the sliding door 7 is entirely closed. Similarly, FIG. 6a) shows the carriage unit together with the area of the ramp 25 of the guiding rail 24 in a perspective view in the vertical position, and FIG. 6b) shows the carriage unit in the tilted position. In FIGS. 6a) and b), of course only the carriage unit 20 is moveable, but not the ramp 25, which is attached locally fixed to the carrier plate 1. In relation to the single elements marked with reference numerals as used in FIG. 3, reference is made essentially to FIG. 3. In this case, the front cover 16 is illustrated in a flapped-down position. The fastening element 29 has a projection which partially engages over the lower leg of the front cover 16, such that no too large a recess remains between the suspension device and the sliding door, while simultaneously allowing the sliding door to both be displaced by a pivotal motion into the door opening and to be lowered without problems when entering the closing area.

Furthermore, it can be recognized that the fastening element 29 furthermore comprises a driver plate 31, which can be connected at the top with the toothed drive belt 32.

The guiding rail 24 is also attached to the carrier plate 1 over screws 26 in a longitudinal groove provided for that purpose. The guiding rail 24 has a ramp 25, which is according to the trajectory described by the guiding roll during the tilting of the carriage unit 20. Thereby the form of the ramp can be adjusted to the entering into the sealing area. It is for instance possible to first begin the pivotal motion slowly and then strongly increase the slope of the ramp toward the meeting of the final position. Furthermore, the ramp 25 has an outer guiding device 35, on which the guiding roll 6 normally rolls off when entering the closing area. In order to ensure that this movement, which is exercised on the carriage unit without any application of force, resulting essentially from the gravitational force of the door, and the lever effect due to the laterally arranged axis 27 and accordingly due to the tilting moment can be guaranteed in every case, in addition an inner guiding device 36, which forces the carriage unit 20 into the tilted position 34, is provided on the guiding rail 24. Accordingly, it isn't absolutely necessary to arrange the axis 27 in a laterally offset way, but said axis can also be located on the roll 5 directly below the line of gravity, if a guiding rail 24 is provided for it, which for instance is able to force the carriage 20 into the tilted position over the inner guiding device 36.

During the mounting process of a suspension device according to the invention, the following procedure can be applied:

The carrier plate 1 is adjusted to the necessary length, which equals about double the width of the door opening 9.

The carrier plate 1 is attached to the top frame by means of screws 2.

The track profile 3 is attached to the carrier plate 1 with screws 4 after having been adjusted to the necessary length, for the purpose of which corresponding profile grooves or bore thread bores are already provided for in the carrier plate 1.

The guiding rail 24 is also screwed to the carrier plate from the bottom by means of screws 26, similarly in the area of the ramp 25, provided that said ramp is not already attached with the guiding rail 24 or is formed in one piece with the guiding rail 24.

The functional elements as the motor 10, the control unit 11, the rear guiding roll 37 etc. are attached to the carrier plate 1, and the toothed drive belt 32 is inserted.

The sliding door, on the top edge of which the carriage unit 20 has been attached by screws, is pushed into the suspension device from the side facing away from the door opening, such that the track rollers 5 run on the track profile 3 and the guiding roll 6 is guided by the guiding rail.

The fine adjustment of the door is achieved on the one hand by adjustment of the height and by adjustment of the tilt of the carriage unit in relation to the sliding door. On the other hand, the adjustment of the entrance into the closing area can be achieved by the adjustment of the position of the guiding roll 6, which, as already mentioned above, is easily possible over the advantageously provided possibility of longitudinal displacement of the guiding roll along the tilting rod 22.

Before or after inserting the sliding door 7, the floor guidances 13-15 can furthermore be attached in the floor area. In addition, these can also be aligned in relation to the adjustment of the entire sliding door.

### LIST OF REFERENCE NUMERALS

1 carrier plate

2 screws for fastening 1 to the frame

3 track profile

4 screws for fastening 2 to 1

5 track roller

6 guiding roll

7 wing of door

8 frame

9 door opening

10 motor

11 control unit

12 drive wheel for toothed drive belt

13 middle bottom guidance

14 rear bottom guidance

15 front bottom guidance

16 cover

17 spring

18 running surface

19 guiding roll

20 carriage unit

21 carriage plate

22 tilting rod

23 screw for fastening 6 to 22

24 guiding rail

25 ramp

26 screw for fastening 24 to 1

27 rotating axis

28 holder for 27 on 21

29 fastening element

30 screw for fastening of 29 to 7

31 driver plate

32 toothed drive belt

33 vertical position of 20

34 tilted position of 20

35 outer guiding device of 25

36 inner guiding device of 25

37 rear guiding roll for toothed drive belt

38 slide bearing

39 fixing rail

40 sealing

1-22. (canceled)

23. A suspension device for at least one sliding door for closing a door or window opening, whereby the sliding door is displaceably mounted by means of at least two track rollers that roll on at least one track profile, and whereby said sliding door is displaced in the direction of the door opening as well as lowered when entering the closing area,
wherein the track rollers are moveably attached to the sliding door, and
wherein the track rollers are arranged essentially vertically in their position outside of the closing area, and
wherein the track rollers tilt laterally out of the vertical when entering the closing area,
whereby the sliding door is displaced in the direction of the door opening by a pivotal motion about a horizontal axis arranged parallel to the plane of the sliding door, and is concomitantly lowered.

24. The suspension device of claim 23, wherein the displacement and lowering of the sliding door results essentially from gravitational force.

25. The suspension device according to claim 23, wherein means are provided which control the tilting of the track rollers when entering the closing area.

26. The suspension device according to claim 25, wherein the means are at least one guiding roll, said guiding roll preventing a tilting of the track rollers in a position outside of the closing area and allowing a tilting of the track rollers when entering the closing area.

27. The suspension device according to claim 26, wherein the axis of the guiding roll is provided rigidly with respect to the axis of the track rollers.

28. The suspension device according to claim 26, wherein at least one said guiding roll is guided by a guiding rail with a ramp in the form of a guiding device in the closing area.

29. The suspension device according to claim 26, wherein the guiding roll is provided such that its axis is oriented essentially vertically in the position outside of the closing area, and that its axis is tilted synchronously to the tilting of the track rollers when entering the closing area.

30. The suspension device of claim 29, wherein the guiding roll is located above the track roller, and wherein the axis of the guiding roll, preferably in the position outside of the closing area, is essentially aligned with the running surface of the track rollers.

31. The suspension device according to claim 26, wherein the guiding roll is adjustable in its position in the direction of displacement of the sliding door.

32. The suspension device according to claim 23, wherein at least one carriage unit, which is rotatable around at least one rotating axis aligned horizontally and parallel to the plane of the sliding door, is provided on the sliding door, and wherein the track rollers are provided on the part of the carriage unit which is moveable relative to the sliding door.

33. The suspension device of claim 32, wherein the rotating axis is arranged offset in the direction facing away from the door opening from the roller-plane of the track rollers.

34. The suspension device of claim 32, wherein the rotating axis is arranged essentially in the area of the top edge of the sliding door.

35. The suspension device according to claim 32, wherein the carriage unit comprises at least two carriage plates which are attached moveably around the rotating axis to the sliding door, and on each of which at least one track roller, preferably two track rollers, are provided.

36. The suspension device of claim 35, wherein the carriage plates are rigidly connected to each other by a tilting rod, and wherein means for controlling the tilting of the track rollers when entering the closing area are provided on the tilting rod, wherein the tilting rod is preferably provided as a rail attached to the top edge of the corresponding carriage plate, on the top side of which a guiding roll is provided between the carriage plates with a vertical orientation of its axis.

37. The suspension device according to claim 23, wherein the track profile has a convex running surface directed upward and wherein the track rollers have a corresponding concave running surface.

38. The suspension device of claim 37, wherein the track profile has a concave opposite surface directed downward, in which at least one guiding roll runs, the axis of which is arranged parallel to the direction of the axis of the track roller.

39. The suspension device according to claim 23, wherein an energy storage device, as for example in form of a spring, an elastic device or a shock absorber is provided, which when entering the closing area takes up energy such that said energy is available when exiting the closing area.

40. The suspension device according to claim 23, wherein the sliding door is an automatic sliding door.

41. The suspension device of claim 40, wherein in the suspension area a motor as well as preferably a control unit is provided, whereby the motor displaces the sliding door over a toothed drive belt, which is fixedly connected with the carriage unit.

42. A sliding door construction with a suspension device for at least one sliding door for closing a door or window opening, whereby the sliding door is displaceably mounted by means of at least two track rollers that roll on at least one track profile, and whereby said sliding door is displaced in the direction of the door opening as well as lowered when entering the closing area,
wherein the track rollers are moveably attached to the sliding door, and
wherein the track rollers are arranged essentially vertically in their position outside of the closing area, and
wherein the track rollers tilt laterally out of the vertical when entering the closing area,
whereby the sliding door is displaced in the direction of the door opening by a pivotal motion about a horizontal axis arranged parallel to the plane of the sliding door, and is concomitantly lowered.

43. The sliding door construction of claim 42, wherein in the floor area there is provided at least one bottom guidance.

44. A method for mounting a suspension device for at least one sliding door for closing a door or window opening, whereby the sliding door is displaceably mounted by means of at least two track rollers that roll on at least one track profile, and whereby said sliding door is displaced in the direction of the door opening as well as lowered when entering the closing area, wherein the track rollers are moveably attached to the sliding door, wherein the track rollers are arranged essentially vertically in their position outside of the closing area, wherein the track rollers tilt laterally out of the vertical when entering the closing area, and whereby the sliding door is displaced in the direction of the door opening by a pivotal motion about a horizontal axis arranged parallel to the plane of the sliding door, and is concomitantly lowered, wherein, in accordance with the method, first a carrier plate is attached to an upper door lintel, then a track profile and a guiding rail are attached to the carrier plate, after which the sliding door is slid into the suspension device from the side or from the front, whereby track rollers of the sliding door are mounted onto the track profile and a guiding roll of the sliding door is inserted into the guiding rail.
